(19) United States
(12) Patent Application Publication
(10) Pub. No.: US 2003/0106400 A1
(43) Pub. Date: Jun. 12, 2003

(54) Die assembly

(76) Inventors: Michael Patrick Lyons, Simpsonville, SC (US); Michael Anthony Byrne, Simpsonville, SC (US)

Correspondence Address: PILLSBURY WINTHROP, LLP, P.O. BOX 10500, MCLEAN, VA, 22102, US

(21) Appl. No.: 10/007,692

(22) Filed: Dec. 10, 2001

(51) Int. Cl. B26F 1/14

(52) U.S. Cl. 83/13; 83/684

(57) ABSTRACT

A die assembly including a base, an adjustable post, and an impacting post. The adjustable post is slidably coupled to the base and movable between first and second cutting positions to cut differently sized items. The impacting post is movable between an impact position proximate the adjustable post and a removed position displaced from the adjustable post.

### FIELD OF THE INVENTION

The present invention relates to die assemblies. More specifically, the illustrated embodiment of the present invention relates to adjustable die assemblies for cutting differently sized items.

### BACKGROUND OF THE INVENTION

Commonly, sheets of material are cut by feeding the sheets through a pair of cutting members that move relative to each other. At least one of the cutting members moves along a cutting axis and moves through the sheet of material to cut the material. Generally, if sheets of a different thickness need to be cut, a different pair of cutting members that are configured specifically for the different thickness is used, which creates inefficiencies. This is especially true with respect to cutting sheets of metal.

### SUMMARY

The present invention can be embodied in a die assembly comprising a base; a lower, adjustable post having a base-contacting surface that is mounted for linear movement with respect to the base between a first cutting position and a second cutting position, including movement in a first direction; a first force applying mechanism coupled to the base and to the adjustable post to move the adjustable post between the first cutting position and the second cutting position; an upper, impacting post being movable between an impact position proximate to the adjustable post and an elevated, removed position in which the impacting post is displaced away from the impact position and the adjustable post, including being movable in a second direction that is transverse to the first direction; and a second force applying mechanism coupled to the impacting post to move the impacting post between the removed position and the impact position.

The present invention can be embodied in a method for cutting comprising providing a die assembly having a base, an adjustable post coupled to the base in a first position such that the adjustable post is linearly movable with respect to the base, and an impacting post movable between an impact position proximate to the adjustable post and a removed position in which the impacting post is displaced away from the impact position and the adjustable post; inserting a first piece of a first material having a first thickness between the adjustable post and the impact post; moving the impacting post along a fixed cutting axis from the removed position to the impact position and cutting the first piece of the first material; moving the impacting post to the removed position; sliding the adjustable post along the base to a second position; inserting a first piece of a second material between the adjustable post and the impact post, the second piece of the second material having a second thickness; and moving the impacting post along the fixed cutting axis from the removed position to the impact position and cutting the second piece of the second material.

Other aspects, features, and advantages of the present invention will become apparent from the following detailed description of the illustrated embodiment, the accompanying drawings, and the appended claims.

### BRIEF DESCRIPTION OF THE DRAWINGS

FIG. 1 shows a partial, perspective view of an illustrative embodiment of a die assembly;

FIG. 2 is a front view of the die assembly of FIG. 1;

FIG. 3 is a plan view of the die assembly of FIG. 1;

FIGS. 4 and 5 show partial, front views of the die assembly of FIG. 1 in a removed and impact positions, respectively, and configured for cutting a relatively thick sheet; and

FIGS. 6 and 7 show partial, front views of the die assembly of FIG. 1 in a removed and impact positions, respectively, and configured for cutting a relatively thin sheet.

### DETAILED DESCRIPTION

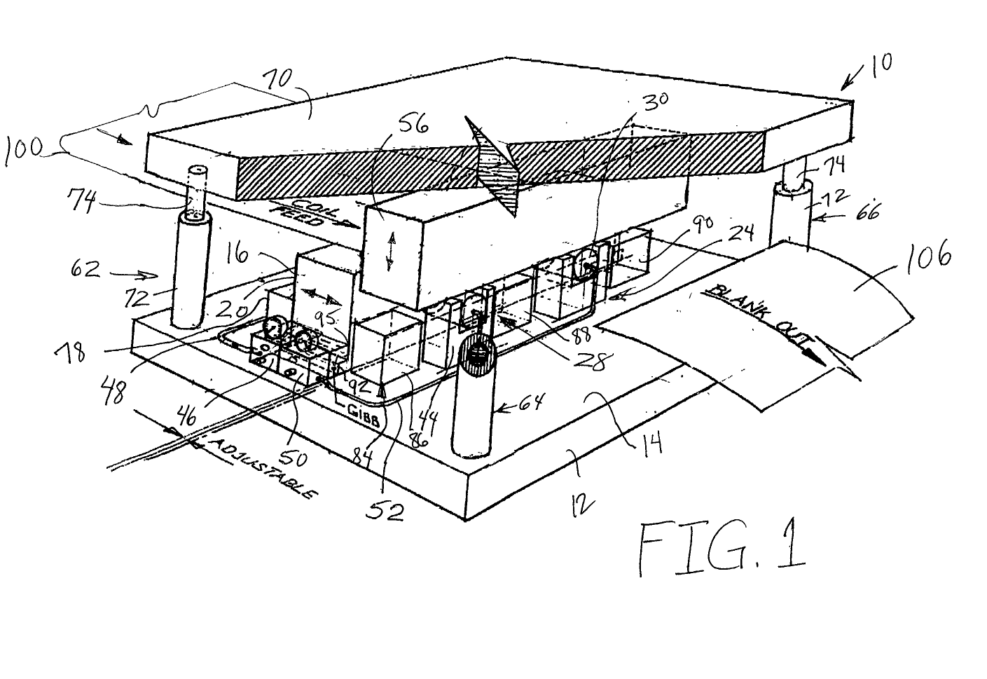

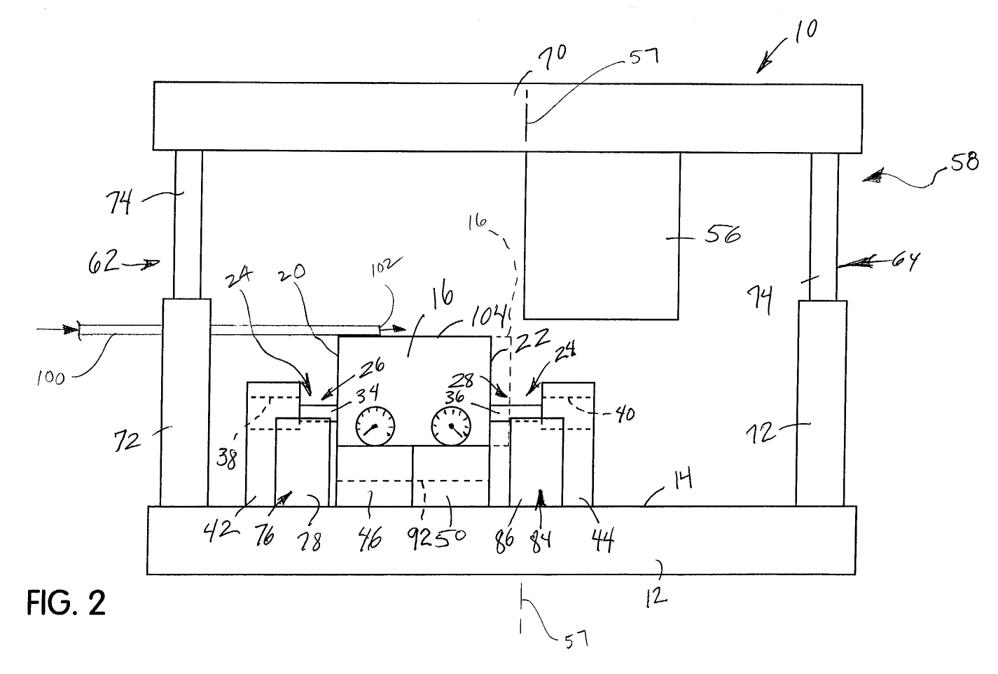

FIGS. 1-7 show an illustrative embodiment of a die assembly 10 that may be used to cut strips 100 of material of various thicknesses into individual blanks. The strip 100 is placed between an adjustable post 16 and an impacting post 56 of the die assembly 10. The end portion 102 of the strip 100 is cut off from the rest of the strip 100 by moving the impacting post 56 generally vertically downwardly with respect to the adjustable post 16. The impacting post 56 is then raised to allow another end portion 102 of the strip 100 to again be placed between the adjustable post 16 and the impacting post 56. The die assembly 10 is operable to cut the strip 100 into a series of blanks 106. As seen in FIG. 2, the adjustable post 16 can be moved toward and away from the cutting axis 57 of the impacting post 56 (as seen in solid and dashed lines in FIG. 2) to adjust the cutting distance between the posts 16, 56. The cutting distance may be changed to allow the die assembly 10 to be used to cut materials of different thicknesses. Generally, the thicker the material being cut, the farther the posts 16, 56 are spaced from one another to assure a clean cut. The strip 100 can be any sheet material desired for cutting, such as metal or plastic. For example, coils of steel sheet metal can be cut by the die assembly 10.

As seen in FIGS. 1-7, the die assembly 10 includes a base 12. The base 12 is in the form of a plate which may be constructed of a metal material such as steel or other material of suitable strength. The base 12 has a substantially flat upper surface 14.

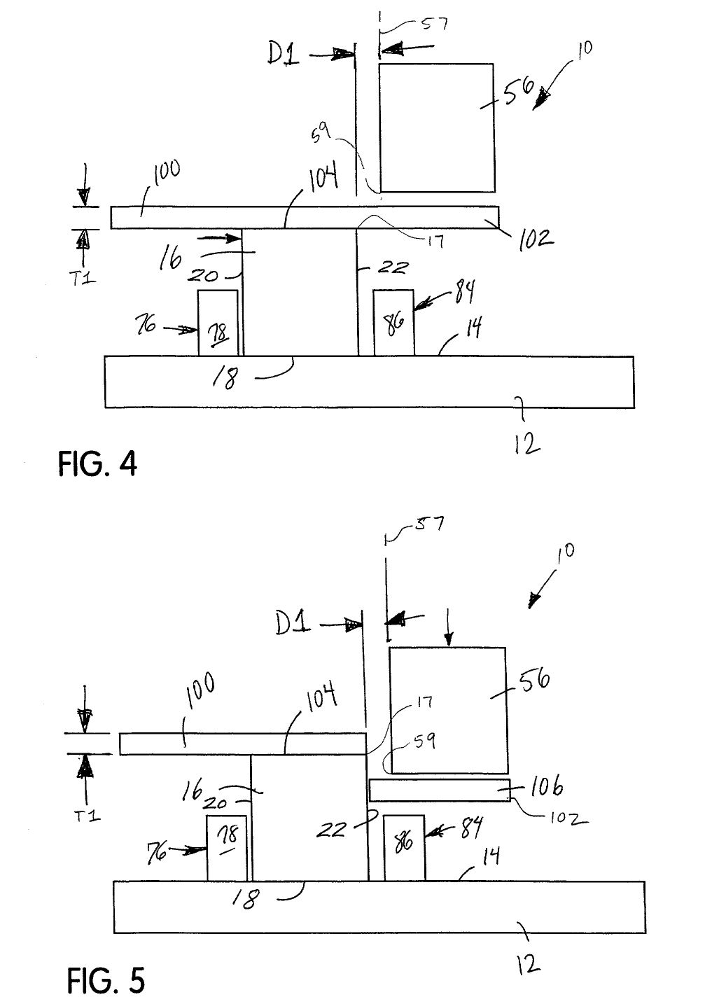

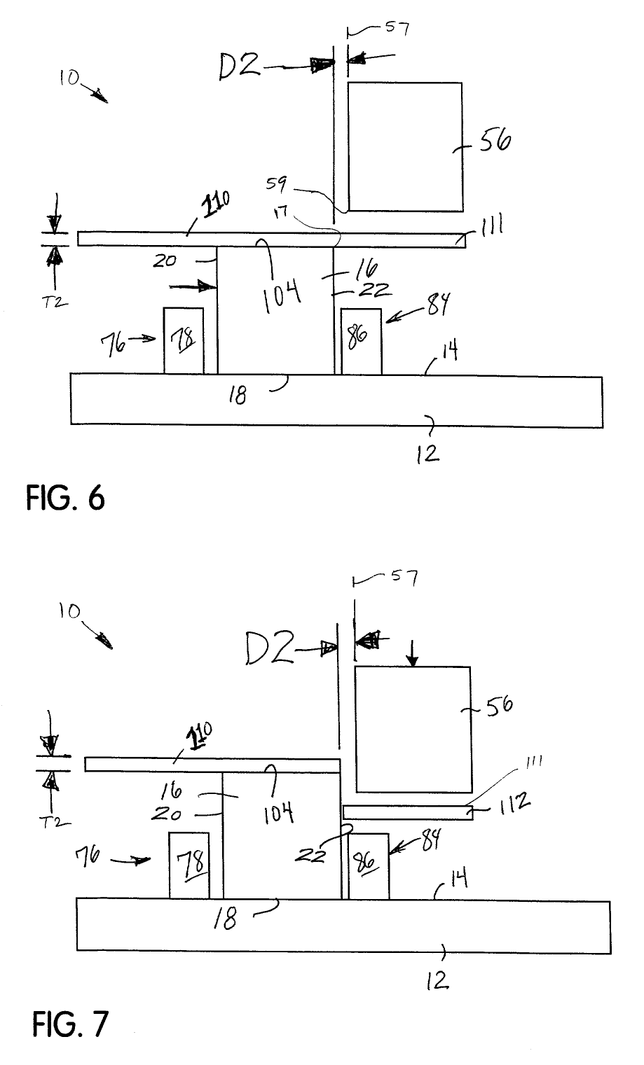

The adjustable post 16 is movably mounted on the base 12. The adjustable post 16 is in the form of an elongated block which may be constructed of a metal material such as steel, or of other material of suitable strength. Although various configurations are possible, the adjustable post 16 as illustrated includes a substantially flat base-contacting bottom surface 18 that is slidably coupled to the upper surface 14 of the base 12. The adjustable post 16 slides along the upper surface 14 of the base 12 in a substantially horizontal direction. The adjustable post 16 includes a first side 20 and a second side 22 which is opposite the first side 20. The first and second sides 20, 22 extend vertically in the example adjustable post 16. Preferably, the adjustable post 16 has a relatively sharp edge 17 to aid in cutting the sheet 110, as seen in FIGS. 4 and 6. Although the adjustable post 16 is shown and described as being slidably coupled to the base 12, this is an example and is not intended to be limiting. The adjustable post 16 could be supported by rollers, for example, or by any other appropriate mechanism. Also, although the adjustable post 16 is illustrated as moving in a straight line, other movement is possible as well, for example, in a curved line.

A first force applying mechanism 24 is coupled to the base 12 and to the adjustable post 16 to move the adjustable post 16 with respect to the base 12. Any appropriate force applying mechanism may be used. In the illustrated embodiment, as seen in FIGS. 1-3, the first force applying mechanism 24 may be in the form of a plurality of pressure cylinders 26, 28, 30, 32. The pressure cylinders 26 and 32 are positioned adjacent the first side 20 of the adjustable post 16. The pressure cylinders 28 and 30 are positioned adjacent the second side 22 of the adjustable post 16. The pressure cylinders 26, 28, 30, 32 are substantially identical to one another so only pressure cylinders 26 and 28 (and associated structures) are considered in detail.

Each pressure cylinder 26, 28 includes a respective rod 34, 36 mounted in the associated cylinder 26, 28 for the respective rod's 34, 36 reciprocal movement toward and away from the adjustable post 16. The rod 34 is positioned adjacent the first side 20 of the adjustable post 16 and can be operated to apply pressure on the first side 20 of the adjustable post 16. The rod 36 is positioned adjacent the second side 22 of the adjustable post 16 and can be operated to apply pressure to the second side 22 of the adjustable post 16. Each cylinder 26, 28 is mounted on a respective cylinder support structure 42, 44. Each cylinder support structure 42, 44 is secured to the base 12 and operates to hold the associated cylinder 26, 28 in vertically spaced relation above the base 12, as desired. It should be understood that although two cylinders 26, 28, 30, 32 are positioned on each side 20, 22 of the adjustable post 16, one centrally located cylinder 26, 28, 30, or 32 may be used on each side 20, 22, or, alternatively, just one cylinder 26, 28, 30, or 32 may be used on one side 20 or 22 to both push and pull the adjustable post 16.

The pressure cylinders 26 and 32 are in fluid communication through hoses or tubing 48 with a controller 46 of pressurized fluid, as is known in the art. Likewise, the pressure cylinders 28 and 30 are in fluid communication through hose or tubing 52 with a controller 50 of pressurized fluid. Each controller 46 and 50 is operable to supply pressurized fluid to the associated cylinder 26, 32 and 28, 30 which causes the respective rod 34, 36 to move outwardly toward or away from the adjustable post 16. The controller 46, 50 can be connected to a single pressurized fluid source or to respective, individual sources. Any appropriate pressurized fluid may be used, including any appropriate pressurized gas or liquid. For example, a gas such as nitrogen gas or a fluid such as hydraulic fluid may be used.

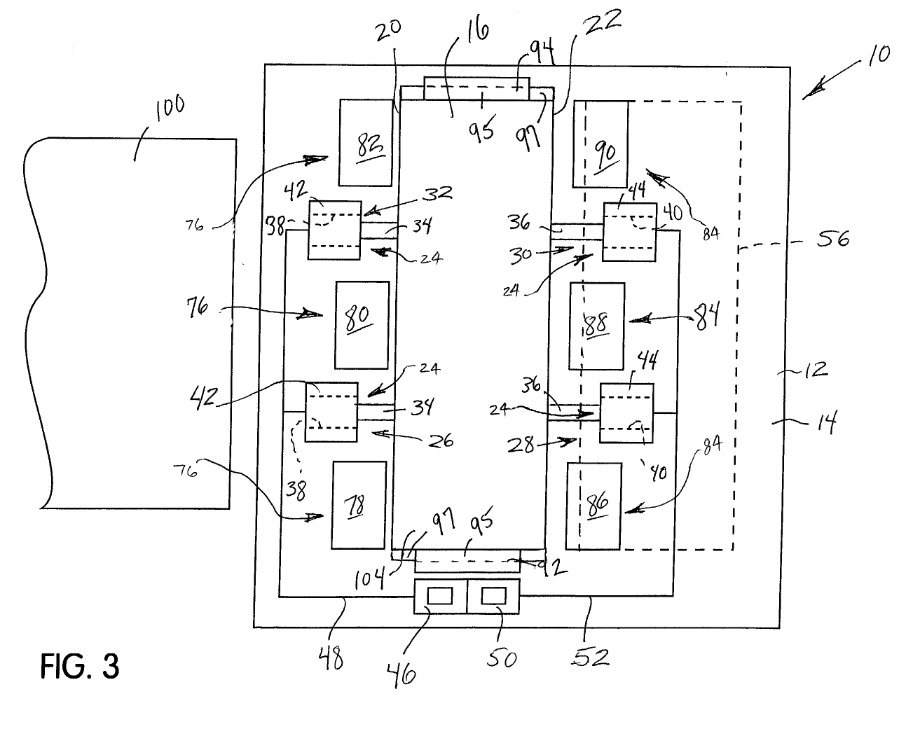

As best seen in FIG. 3, stops 78, 80, 82, 86 88 and 90 are coupled to limit the movement of the adjustable post 16. First stop 76 is attached to the base 12 in a first predetermined position on the base 12. The first stop 76 includes a series of three blocks 78, 80, 82 that are space apart from one another along the side 20 of the adjustable post 16 and limits movement of the adjustable post 16 from moving too far to the left as seen in FIG. 3. A second stop 84 is attached to the base 12 in a second predetermined position on the base 12 and limits movement of the adjustable post 16 from moving too far to the right as seen in FIG. 3. The second stop 84 includes a series of blocks 86, 88, 90 that are spaced apart from one another along the side 22 of the adjustable post 16. The first and second stops 78, 84 limit the range of movement of the adjustable post 16 with respect to the base 12 and with respect to the impacting post 56 when the adjustable post 16 is moved toward and away from the impacting post 56 to adjust the cutting distance between the posts 16, 56. As seen in FIG. 2, the location of stop 84 helps prevent the adjustable post 16 from moving beneath the impacting post 56.

As seen in FIGS. 1-3, two gibs 92, 94 are attached to the base 12. Each gib 92, 94 is positioned on a respective opposite end of the adjustable post 16. Each gib 92, 94 is coupled to the adjustable post 16 to permit movement of the adjustable post 16 toward and away from the impacting post 56. The gibs 92, 94 generally restrict the movement of the adjustable post 16 to a path along a single substantially horizontal axis toward and away from the impacting post 56. Each gib 92, 94 has an upper protruding portion 95 to engage a respective upwardly facing surface 97 on the adjustable post 16 to prevent the adjustable post 16 from lifting upwardly away from the base 12 during operation of the die assembly 10.

As seen in FIGS. 1-7, the impacting post 56 is mounted in a position spaced above the base 12 for generally vertical movement with respect to the adjustable post 16. The impacting post 56 is illustrated as an elongated block-like structure that may be constructed of a metal material such as a steel or of other material of suitable strength. Preferably, the impacting post 56 has a relatively sharp edge 59 to aid in cutting the sheet 100 as seen in FIGS. 4 and 6.

A second force applying mechanism 58 is operatively connected to the impacting post 56 and is operable to apply force to the impacting post 56 to move the impacting post 56 with respect to the adjustable post 16 along the generally vertical cutting axis 57. Although several of the moving components of the die assembly 10 (such as the adjustable post 16 and the impacting post 56) are illustrated and described using horizontal and vertical movement, this is not intended to limit the orientation of the die assembly or any of the components of the die assembly 10 or to restrict the relative angles of movement of the moving components. For example, although a generally vertical cutting axis 57 is illustrated, the cutting axis can be at any appropriate orientation or angel with respect to the adjustable post 16 so long as the impacting post 56 moves sufficiently relative to the adjustable post 16 to cut the sheet 100 as desired. Furthermore, the impacting post 56 could be angularly mounted in the die assembly so that the impacting post 56 provides a shearing action to sever a strip of metal material. The second force applying mechanism 58 may be supported by the base 12 and be positioned above the base 12 as seen in FIGS. 1 and 2. Although any appropriate force applying mechanism may be used, the illustrative embodiment of the second force applying mechanism 58 includes a plurality of pressure cylinders 62, 64, 66, 68 and an upper support structure 70. Also, though the cutting path of impacting post 56 is illustrated as being along an axis, that is, cutting axis 57, the cutting path can be any movement relative to the adjusting post that cuts the desired material. For example, the cutting path of impacting post can cut sheet 100 along a curved line that is fixed with respect to the movement of the adjustable post 16.

The pressure cylinders 62, 64, 66, 68 are substantially identical to one another, so only the pressure cylinder 62 is discussed in detail. The pressure cylinder 62 includes a movable rod 74. One end of the cylinder 62 is fixedly mounted with respect to the base 12. The free end of the rod 74 is connected to the upper support structure 70. The rod 74 can be moved vertically to lift and lower the upper support structure 70. The cylinders 62, 64, 66, 68 are in fluid communication with a controller of pressurized gas or liquid to control the up and down movement of the rod 74 of each cylinder 62, 64, 66, 68 and thus to control the up and down movement of the upper support structure 70 with respect to the base 12 and the adjustable post 16. Cylinders 62, 64, 66 and 68 may be substantially similar to the cylinders 26, 28, 30 and 32 discussed above and use similar or different pressurized fluid including pressurized gasses or liquids, such as nitrogen gas or hydraulic fluid. Also, various numbers and configurations of pressure cylinders can be used.

The first force applying mechanism 24 and the second force applying mechanism 58 are each shown as including a plurality of fluid pressure cylinders. It can be understood that this is an example only and that any appropriate force applying mechanism or mechanisms can be used (such as mechanisms using screw threads, gearing and so on) to move the adjustable post 16 and the impacting post 56.

The upper support structure 70 may be a plate-like structure constructed of a metal material such as a steel or other material of suitable strength. The impacting post 56 is fixedly attached to the upper support structure 70 so that movement of the upper support structure 70 moves the impacting post 56 up and down with respect to the adjustable post 16. Other force applying mechanisms may be used to move the impacting post 56 such as mechanisms not directly attached to the supporting structure for adjustable post 16. For example, a force applying mechanism attached to a different structure that is fixed with respect to the base 12 may be used, such as a single pressure cylinder appropriately coupled to the impacting post 56 and an adjacent upstanding structure.

### Operation

As seen in FIGS. 2 and 4-7, a longitudinally extending strip of material 100 is fed into the die assembly 10. The strip 100 may be derived from a coil of material that has been unwound and (optionally) flattened prior to being fed into the die assembly 10, as illustrated. The strip 100 is positioned on the adjustable post 16 so that a free end 102 of the strip 100 is positioned beyond the cutting axis 57 to a predetermined position depending on the desired length of material to be cut, as seen in FIG. 4. The second force applying mechanism 58 is actuated to move the impacting post 56 downwardly from a removed position as in FIG. 4 in which to the impacting post 56 is displaced away from the adjustable post 16 and from the strip 100, to an impact position as in FIG. 5 in which the impacting post 56 is proximate to the adjustable post 16. As the sharp edge 59 of the impacting post 56 moves downwardly past the top surface 104 and the sharp edge 17 of the adjustable post 16, the end 102 of the strip 100 is severed creating a blank 106 of predetermined length. The second force applying mechanism 58 moves the impacting post 56 generally vertically along the cutting axis 57 in the illustrative embodiment. The cutting axis 57 of the impacting post 56 does not move with respect to the base 12 during operation of the die assembly 10. After the cutting, the second force applying mechanism 58 moves the impacting post 56 back to the removed position so that the process can be repeated. The blank 106 may fall onto a conveyor-type apparatus (not shown) for movement of the blank 106 out of an exit side of the die assembly 10 or may be otherwise removed from the die assembly 10.

If the characteristics of the item being cut change, the spacing or cutting distance between the adjustable post 16 and the cutting axis 57 may also need to be changed. The first force applying mechanism 24 can be operated to move the adjustable post 16 along the base 12 to adjust the cutting position of the adjustable post 16 and thereby adjust the cutting distance between the adjustable post 16 and the cutting axis 57. This adjustment of the cutting distance can be understood by comparing FIGS. 4 and 5 with FIGS. 6 and 7. Such an adjustment may be necessitated by, for instance, a change of thickness in the material being cut.

In FIGS. 4 and 5, the cutting distance between the adjustable post 16 and the impacting post 56 is labeled D1. In the example die assembly 10, the cutting distance is essentially a measure of the distance between the cutting edge 17 of the adjustable post 16 and the cutting axis 57 of the impacting post 56. In FIGS. 6 and 7 the cutting distance is D2, which is smaller than D1 because the thickness T2 is the sheet 110 is thicker than the thickness T1 of sheet 100.

The cutting distance required to cut a particular strip of material “cleanly” (i.e., straight across, with no jagged edges, and so on) depends on the properties, characteristics and dimensions of the strip (e.g., the thickness of the strip, the hardness of the material of the strip, and so on). For example, generally, the thicker the material of a strip, such as strips 100 and 110, the greater the cutting distance must be to assure a clean cut. FIGS. 4 and 5 show the strip 100 having a thickness T1 and show the adjustable post 16 in a first cutting position with respect to the impacting post 56 so that the strip 100 is being cut with a cutting distance of D1. FIGS. 6 and 7 show a strip 110 having a thickness T2 (where T2 is less than T1) and show the adjustable post 16 moved to a second cutting position with respect to the cutting axis 57 of the impacting post 56 to change the cutting distance to accommodate the different thickness of strip 110. When the impacting post 56 is actuated, the strip 110 is cut and a free end 111 of the strip 110 is severed to form a blank 112 of predetermined length. Because T2 is less than T1, the cutting distance D1 used for sheet 100 may be reduced to D2 to assure a clean cut of the strip 110. This may be required, for example, in instances in which the strips 100 and 110 are formed of substantially identical material, and differ from one another only in thickness. The cutting distance required can be determined empirically or calculated based on known differences in the characteristics of the various strips to be cut.

It can be appreciated that this arrangement in which the adjustable post 16 of the die assembly is adjustable to change the cutting distance allows a manufacturer to cut a wide range of strips of metal material having a wide range of characteristics (thickness, hardness, and so on) with a single die assembly. Thus, the manufacturer does not need, for example, a plurality of dies to accommodate a plurality of strip thicknesses.

In the illustrative embodiment, the cutting distance can be easily changed by sliding the adjustable post 16 horizontally in the longitudinal direction along the base 12. To move the adjustable post 16 to decrease the cutting distance from D1 to D2, the pressure in the pressure cylinders 26 and 32 (see FIG. 3) and the pressure in the pressure cylinders 28 and 30 is appropriately controlled to move the adjustable post 16 as desired. This causes the rods 34 in the assemblies 26 and 32 to push against the first side 20 of the adjustable post 16 and allows the rods 36 of the pressure cylinders 28 and 30 to retract as the second side 22 of the moving adjustable post 16 pushes against them. The adjustable post 16 is moved until the desired cutting distance D2 is achieved. The rods 34, 36 on the opposing sides of the adjustable post 16 may then be pressurized to hold the adjustable post 16 in the desired cutting position while a strip 110 is cut into a series of blanks 112. Movement in the reverse direction to increase the cutting distance may be achieved by operating the force applying mechanism 24 in the reverse manner.

The moving of adjustable post 16 can be manual or automatic. For example, the cylinders 26, 28, 30, 34 can be set to predetermined pressures to move the adjustable post 16 to the desired position for a specific strip 100 or 110. Another example includes utilizing a sensor or sensors to detect the properties of each strip, e.g., thickness, and then automatically changing the position of the adjustable post 16 by, for example, changing the pressure within cylinders 26, 28, 30 and 32. The operation of the die assembly 10 can be partially or fully automated (i.e., computer controlled). It can also be appreciated that although the die assembly 10 is shown in isolation, it is contemplated to possibly incorporate the die assembly 10 into an assembly line of a manufacturing facility for use in conjunction with a series of other apparatus or stations both upstream of the die assembly (such as uncoiling stations, smoothing/straightening stations, punching/piercing stations, and so on) and downstream of the die assembly (such as stamping stations, and so on).

The gibs 92, 94 slidably engage the respective ends of the adjustable post 16 during longitudinal movement of the adjustable post 16 and restrict the adjustable post 16 to movement with respect to the base 12 in a longitudinal direction, that is, toward and away from the cutting axis 57. The gibs 92, 94 prevent lateral movement of the adjustable post 16 with respect to the base 12. The first stop 76 and the second stop 84 limit the movement of the adjustable post 16 in the longitudinal direction between first and second predetermined positions and prohibit the adjustable post 16 from crossing the cutting axis 57, which could damage the posts 16 and 56 upon impact thereof.

It can be understood that the construction and operation of the die assembly 10 shown and described herein is an example only and is intended to illustrate only one embodiment of the invention, but not to limit the scope of the invention. Other embodiments, applications and modes of operation are contemplated and within the scope of the invention.

Thus, while the invention has been disclosed and described with reference with a limited number of embodiments, it will be apparent that variations and modifications may be made thereto without departure from the spirit and scope of the invention. Therefore, the following claims are intended to cover all such modifications, variations, and equivalents thereof in accordance with the principles and advantages noted herein.

What is claimed is:

1. A die assembly, comprising:
a base;
a lower, adjustable post having a base-contacting surface that is mounted for linear movement with respect to said base between a first cutting position and a second cutting position, including movement in a first direction;
a first force applying mechanism coupled to said base and to said adjustable post to move said adjustable post between said first cutting position and said second cutting position;
an upper, impacting post being movable between an impact position proximate to said adjustable post and an elevated, removed position in which said impacting post is displaced away from said impact position and said adjustable post, including being movable in a second direction that is transverse to said first direction; and
a second force applying mechanism coupled to said impacting post to move said impacting post between said removed position and said impact position.

2. A die assembly according to claim 1, wherein
said base has a substantially flat upper surface for supporting said adjustable post.

3. A die assembly according to claim 1, wherein
said adjustable post is slidably coupled to said base.

4. A die assembly according to claim 2, wherein
said base-contacting surface is substantially flat and moves along said upper surface of said base in substantially horizontal directions.

5. A die assembly according to claim 1, wherein
said first force applying mechanism is a pressure cylinder.

6. A die assembly according to claim 1, wherein
said pressure cylinder contains nitrogen.

7. A die assembly according to claim 1, wherein
said adjustable post includes a first side and a second side, which is opposite to said first side, and said first force applying mechanism includes a first pressure cylinder positioned adjacent to said first side of said adjustable post to apply pressure on said first side of said adjustable post and a second pressure cylinder positioned adjacent to said second side of said adjustable post to apply pressure on said second side of said adjustable post.

8. A die assembly according to claim 1, wherein
said second force applying mechanism is supported by said base and positioned above said base.

9. A die assembly according to claim 1, wherein
said second force applying mechanism includes a pressure cylinder.

10. A die assembly according to claim 1, wherein
said first direction is along a first axis and second directions is along a second axis.

11. A die assembly according to claim 1, wherein
said impacting post moves along a fixed, substantially vertical cutting axis.

12. A die assembly according to claim 1, further comprising:
a first stop attached to said base in a first predetermined position on said base and aligned with said adjustable post to prohibit said adjustable post from moving beyond said first predetermined position.

13. A die assembly according to claim 12, further comprising:
a second stop attached to said base in a second predetermined position on said base and aligned with said adjustable post to prohibit said adjustable post from moving beyond said second predetermined position.

14. A die assembly according to claim 10, further comprising:
a gib attached to said base and coupled to said adjustable post to permit movement of said adjustable post only along a single axis.

15. A method of cutting, comprising:
providing a die assembly having a base, an adjustable post coupled to the base in a first position such that the adjustable post is linearly movable with respect to the base, and an impacting post movable between an impact position proximate to the adjustable post and a removed position in which the impacting post is displaced away from the impact position and the adjustable post;
inserting a first piece of a first material between the adjustable post and the impact post, the first piece of the first material having a first thickness;
moving the impacting post along a fixed cutting axis from the removed position to the impact position and cutting the first piece of the first material;
moving the impacting post to the removed position;
sliding the adjustable post along the base to a second position;
inserting a first piece of a second material between the adjustable post and the impact post, the first piece of the second material having a second thickness; and
moving the impacting post along the fixed cutting axis from the removed position to the impact position and cutting the first piece of the second material.

16. A method according to claim 15, further comprising:
after cutting the first piece of the first material, moving a second piece of the first material between the adjustable post and the impact post;
moving the impacting post along the fixed cutting axis from the removed position to the impact position and cutting the second piece of the first material; and
moving the impacting post to the removed position.

17. A method according to claim 15, wherein
inserting the first piece of the first material between the adjustable post and the impact post, includes inserting a first section of a continuous roll of the first material.

18. A die assembly, comprising:
a base;
an adjustable post having a base-contacting surface that is slidably coupled to said base;
a first force applying mechanism coupled to said base and to said adjustable post to move said adjustable post between a first cutting position and a second cutting position;
a second force applying mechanism; and
an impacting post attached to said second force applying mechanism and movable by said second force applying mechanism between an impact position proximate to said adjustable post and a removed position in which said impacting post is displaced away from said impact position and said adjustable post.

19. A die assembly according to claim 18, wherein
said base has a substantially flat upper surface for supporting said adjustable post.

20. A die assembly according to claim 19, wherein
said base-contacting surface is substantially flat and moves along said upper surface of said base in substantially horizontal directions.
